(19) United States
(12) Patent Application Publication
(10) Pub. No.: US 2007/0230082 A1
(43) Pub. Date: Oct. 4, 2007

(54) INTEGRATED CIRCUIT HAVING A PLURALITY OF EXTERNALLY FED POWER SUPPLY SYSTEMS

(76) Inventor: Peter Poechmueller, Xi'an (CN)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/694,498

(22) Filed: Mar. 30, 2007

(30) Foreign Application Priority Data
Mar. 30, 2006 (DE) 102006014733.2-33

(51) Int. Cl. H02H 9/06

(52) U.S. Cl. 361/118

(57) ABSTRACT

An integrated circuit has at least two supply systems, each of which is connected to an individually assigned section of the integrated circuit to supply power to the relevant section. A low-pass coupler is connected between the at least two supply systems.

### CROSS-REFERENCE TO RELATED APPLICATIONS

This application claims priority to German Patent Application No. 10 2006 014 733.2-33, filed 30 Mar. 2006, which is herein incorporated by reference.

### BACKGROUND OF THE INVENTION

1. Field of the Invention

The invention generally relates to power supplies within integrated circuits.

2. Description of the Related Art

Integrated circuits often contain a plurality of internal power supplies each of which may be connected to an individually assigned section of the circuit for purposes of providing power to the assigned section. Dividing the power supply for different sections of an integrated circuit makes it possible to avoid switching impulses which may be produced by changes in the instantaneous power consumption in a section, being transmitted to other sections via the supply system and resulting in faults in the sections. The internal power supplies are often supplied with power from external power sources via contact areas or pads.

It is often desirable to test integrated circuits at various stages during their production. For example, an integrated circuit may be tested after integration on a wafer, but before being divided into individual chips. In this case, contact is made with the pads of each integrated circuit using a test unit having tests probes in the form of needles. The needles may apply supply voltages to the internal power supplies and may apply tests signals to the integrated circuit. The test unit may detect and monitor response signals generated by the IC in response to the test signals. Furthermore, it may be desirable to test many integrated circuits on the wafer simultaneously to reduce the total amount of time the wafer is to be tested.

Therefore, there exists a need for ways to supply power to a plurality of sections of an IC in order to test the IC while using a limited number of test needles.

### SUMMARY OF THE INVENTION

Embodiments of the invention generally provide apparatus for supplying power to integrated circuits.

According to one embodiment of the invention an integrated circuit is provided. The integrated circuit generally comprising: at least two supply systems, each of which is connected to an individually assigned section of the integrated circuit to supply power to the respective section and a low-pass coupler connected between the at least two supply systems

According to another embodiment of the invention a dynamic random access memory (DRAM) module is provided. The DRAM generally comprising: at least two power supply systems each of which is connected to a data output driver to supply power to the data output driver; and a low-pass coupler connected between the at least two power supply systems.

### BRIEF DESCRIPTION OF THE DRAWINGS

These features of the embodiments of the present invention will become clear from the following description, taking in conjunction with the accompanying drawings. It is to be noted, however, that the accompanying drawings illustrate only typical embodiments of the present invention and are, therefore, not to be considered limiting of the scope of the invention. The present invention may admit other equally effective embodiments.

FIG. 1 shows a schematic illustration of part of an integrated circuit which is mounted in the form of a chip on a housing base.

FIG. 2 shows part of an inventive integrated circuit on a wafer in conjunction with an associated part of a test card.

FIG. 3 shows that part of an integrated circuit which is illustrated in FIG. 2 when mounted on a housing base.

In the drawings, identical or similar elements are denoted using the respective same abbreviations in upper case letters, a serial number in square brackets being added in some cases for more precise identification. A colon between two such numbers means “to.”

### DETAILED DESCRIPTION OF THE PREFERRED EMBODIMENT

The invention relates to an integrated circuit (abbreviated to: “IC”) having a plurality of internal supply systems, each of which is connected to an individually assigned section of the circuit for the purpose of supplying power to the relevant section. One advantageous, but not exclusive, area of application for the invention is in modules for digitally processing, transmitting or storing data, in particular high-performance memories for graphics purposes.

Dividing the power supply for different sections of an IC between separate supply systems makes it possible to avoid switching impulses, which are produced by operation-dictated changes in the instantaneous power consumption in a section, being transmitted to other sections via the supply system and resulting in faults in said sections. The risk of such interfering influences is greater the faster and more severe the change in the current load in a section. Therefore, separate supply systems are preferably used in ICs, which supply systems are intended to operate at high operating frequencies, to be precise, in particular wherever relatively strong signals have to be switched at a high frequency. This applies, in particular, to the transmission amplifiers (off-chip drivers) in high-performance ICs, for example in graphics memories and in associated memory controllers.

Like any electrical supply system, the separate supply systems in an IC thus also each comprise two so-called “busbars” which are connected to the two poles of a DC voltage source during operation. Each busbar is formed by a metalization which passes through the IC or part of the latter in the form of a grid in order to supply the positive or negative DC voltage potential to different circuit units in the relevant section. The supply systems inside the IC are DC-isolated from one another, and a smoothing capacitor having the highest possible capacitance is respectively integrated between the two busbars of each supply system in order to smooth voltage dips to the greatest possible extent in the case of severe changes in the load on the relevant system.

ICs are produced on a semiconductor substrate using lithographic methods, a large number of identical ICs of this type usually being jointly formed on a semiconductor wafer. During integration on the wafer, respective associated contact-making areas, the so-called “pads”, are formed on the relevant IC for all those circuit nodes of an IC to which or from which external signals and voltages need to be supplied or dissipated during subsequent operation. After integration has been completed, the wafer is cut along the boundaries between the individual ICs. The “chips” which are obtained in this manner are then each mounted on a housing base and the pads of the mounted chip are mechanically wired to associated connecting elements, the so-called “pins”, on the base. This structure is then encapsulated, with the result that only the pins remain accessible from the outside.

In a chip having a plurality of separate internal supply systems, two individual pads are provided for each system, one for the “positive” busbar and one for the “negative” busbar of the relevant system. Accordingly, the encapsulated IC module also contains two respective “supply” pins for each internal supply system. The wiring between each pin of the housing and the associated pad of the chip mounted in said housing has a relatively high non-reactive resistance and, in particular, also a relatively high inductance. These so-called “package parasitics” may ensure sufficient decoupling between the different internal supply systems for switching impulses even when the supply pins for a plurality of internal supply systems are externally connected to one another by means of bridges. It is thus practice to provide such external bridges on an encapsulated chip and thus to feed all pairs of supply pins from a common DC voltage source.

It is desirable to test integrated circuits at various stages during their production, for example also at the stage directly after integration on the wafer before being divided into individual chips. In this case, contact is made with the pads of each IC on the wafer using test probes in the form of needles in order to apply supply voltages and test signals and to tap off the response signals, which are generated in response to said voltages and signals, from the IC. The needles are arranged on a test card and are connected to a test unit which transmits the test signals and receives and evaluates the response signals.

In the case of ICs having a plurality of internal supply systems which are isolated from one another, the test card must additionally have, in addition to the needle probes for inputting the test signals and for tapping off the test responses, two needle probes for each supply system, one for applying the positive supply potential and one for applying the negative supply potential. As a result of this, the number of needles required on the test card becomes extremely large, in particular if each IC has a large number of separate supply systems. This large number is multiplied if a plurality of ICs on the wafer is intended to be tested at the same time during parallel operation, which is desirable in order to save time. However, the total number of needles on the test card is limited, both for reasons of cost and on account of different technical restrictions, for example in terms of the contact pressure which must correspond to a weight of approximately 2 grams for each needle, in order to ensure reliable contact with the associated pad. With a given maximum permissible total contact pressure, the possible degree of “parallelism” of the test, that is to say the number of respective ICs on the wafer which can be tested in a parallel manner, is smaller the greater the number of separate supply systems in each IC. However, a smaller degree of parallelism lengthens the test time for the wafer and thus increases the time for which the very expensive test unit is used, thus increasing the overall costs of IC fabrication.

It is desirable to design an IC containing a plurality of separate supply systems in such a manner that the number of needle probes can be reduced during the wafer test.

Accordingly, an embodiment of the invention is implemented in an integrated circuit having a plurality of internal supply systems, each of which may be connected to an individually assigned section of the circuit for the purpose of supplying power to the relevant section and comprises a first busbar for the positive potential of a supply voltage and a second busbar for the negative potential of the supply voltage, each busbar being provided with an integrated contact area for applying the relevant supply potential from an external voltage source (UDC). Furthermore, a low-pass coupler may be internally set up between the supply systems of a respective group of at least two different supply systems.

The internal low-pass coupler between the supply systems of a respective group of a plurality of supply systems of an IC result in DC coupling of the systems, while the systems are decoupled for alternating current, to be precise in a more effective manner the higher the frequency. As a result of the DC coupling, it is sufficient to connect the supply voltage to only one (or only a subset) of the supply systems in each group during the wafer test. This reduces the number of needle probes required for each IC during the wafer test.

After the wafer has been cut, the chips obtained can be encapsulated without having to remove the inventive internal low-pass coupler. If the internal low-pass couplers are formed using non-reactive series resistors and if the systems on the encapsulated chip are fed from a common voltage source using bridges between supply pins (as described further above), the resistance values of the series resistors of the internal low-pass connections must be dimensioned to be so large that they do not counteract the decoupling, which is achieved by means of the package parasitics, to an excessively great extent. That is to say, the non-reactive resistance of each internal low-pass connection should be large in comparison with the equivalent resistance of the package parasitics and should advantageously be at least twice as large.

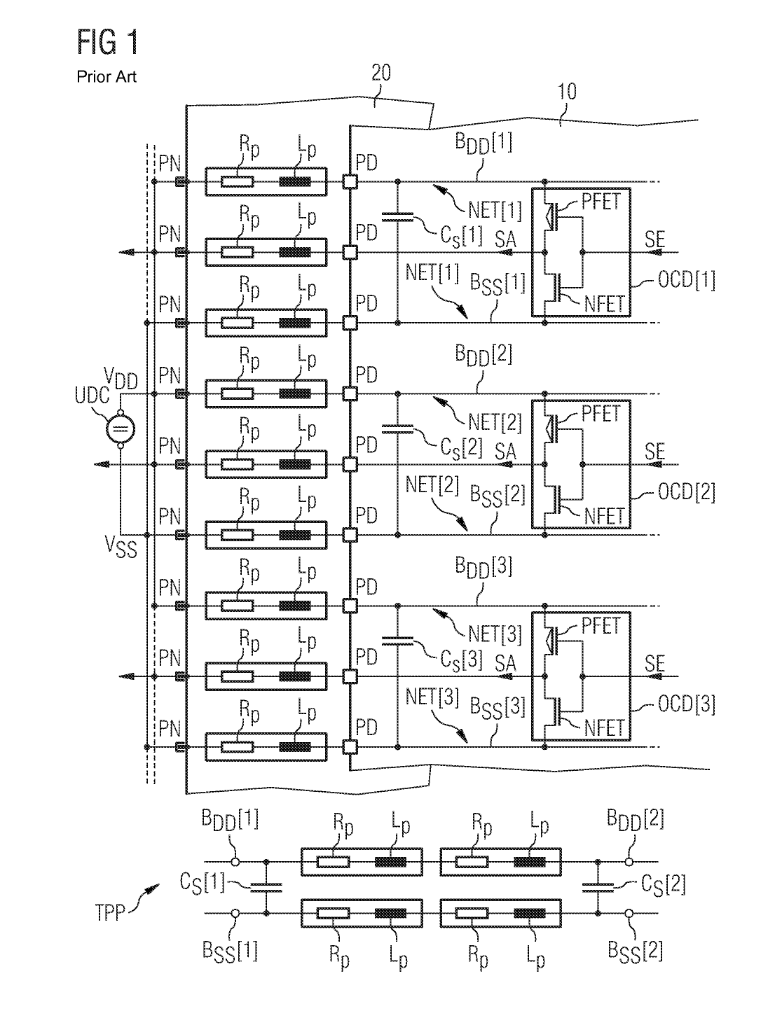

The fragmentary illustration shown in FIG. 1 shows only some of the elements of a circuit (IC) which is integrated on a chip 10, to be precise three output drivers (off-chip drivers) OCD[1:3], each of which receives its supply voltage from an individually assigned supply system NET[1] or NET[2] or NET[3]. Each of these systems NET comprises a first busbar (“positive” busbar) B_{DD} for the more positive potential V_{DD} of the supply voltage and a second busbar (“negative” busbar) B_{SS} for the more negative potential V_{SS} of the supply voltage. A respective smoothing capacitor C_{S} is connected between the two busbars B_{DD} and B_{SS} of each supply system NET. The drivers OCD each have a signal input SE for applying a binary data signal and a signal output SA for outputting the amplified data signal.

A multiplicity of contact-making areas PD which are usually referred to as “pads” are situated at the edge of the chip 10. Two respective pads PD are provided for each of the supply systems NET[1:3], one for making contact with the positive busbar B_{DD} and one for making contact with the negative busbar B_{SS} of the relevant system. The pads PD are each indicated in the drawing in the form of small squares with a bold border as are three further pads which are connected to the signal outputs SE[1:3] of the three drivers OCD[1:3].

It shall be mentioned at this juncture that the chip 10 may of course contain a large number of further separate supply systems each having a positive busbar and a negative busbar and associated pads. Each system may supply its own section of the IC on the chip 10, such sections also of course being able to contain circuits other than the output drivers OCD shown by way of example. The pads PD are used to connect connections to the outside world. Depending on the type and purpose of the IC, a multiplicity of further pads may be provided in order to emit further signals to the outside and to receive signals from the outside.

When ready to use, the chip 10 is mounted inside a housing (not shown) on a base 20 on which the connection contacts PN (“pins”), which are accessible from the outside, are situated. Each pin PN is connected to an associated pad PD of the chip 10 by means of a wire. Each of these wire connections has parasitic impedances which are referred to as “package parasitics.” Effective parasitics are primarily the non-reactive intrinsic resistance R_{P} and the intrinsic inductance L_{P} of the wire connection, as illustrated in the drawing.

The package parasitics on the connections to the busbars B_{DD} and B_{SS} of the supply systems NET in combination with the internal smoothing capacitors C_{S} allow different supply systems NET to be fed from the same voltage source using the external pins, while the relevant systems remain decoupled for alternating currents, albeit in a frequency-dependent manner. Accordingly, it is practice to connect the pins for the positive busbars B_{DD} of all supply systems to one another by means of external bridge conductors and to connect them to the positive pole of a common DC voltage source UDC and to likewise connect the negative busbars of the supply systems to one another by means of external bridge conductors and to connect them to the negative pole of this voltage source UDC.

This manner of connection can be seen in FIG. 1 for the group of systems NET[1:3]. The bridge conductors which are indicated in the form of solid lines to the left of the pins PN also extend to other supply systems of the IC which are not illustrated in the drawing, as indicated using dashed lines in the drawing. Together with the non-reactive and inductive package parasitics R_{P}, L_{P} and the smoothing capacitors C_{S}, the bridges form individual low-pass connections between the systems. The conductor bridges are advantageously dimensioned in such a manner that their impedance is negligibly small, with the result that they can virtually be considered to be short circuits. Each of said low-pass connections can thus be considered to be a four-pole network having two parallel-path impedances each comprising one of the smoothing capacitors C_{S} and a respective series impedance in each of the two longitudinal branches between the parallel-path impedances. Each of these series impedances comprises the series connection of two package wire connections. The bottom part of FIG. 1 illustrates such a low-pass four-pole network TPP, which leads via the package parasitics, on its own, to be precise as an example of that which is effective between the supply systems NET[1] and NET[2].

If the load on a supply system is controlled by means of a pulse such that it draws a current pulse from the relevant system, a certain voltage dip is produced in this system. In the example shown in FIG. 1, the load in each supply system contains, as stated, a transmission driver OCD which is represented in a simplified manner by a P-channel field effect transistor PFET and an N-channel field effect transistor NFET whose channels are arranged in series between the busbars B_{DD} and B_{SS} of the relevant supply system. The gates of the two transistors, which are coupled together, form the signal input SE, and the connecting point between the channels of the two transistors forms the signal output. If a pulse having a positive potential which is equal to or close to V_{DD}, which corresponds to a data bit having the binary value “1,” for example, is applied to the signal input SE, the NFET turns on and charges the signal output SA to the negative potential V_{SS}, the charging current resulting in a positive interference pulse on the negative busbar B_{SS}. If a pulse having a negative potential which is equal to or close to V_{SS}, which corresponds to a data bit having the binary value “0,” for example, is applied to the signal input SE, the PFET turns on and charges the signal output SA to the positive potential V_{DD}, the charging current resulting in a negative interference pulse on the positive busbar B_{DD}.

Said low-pass connections between the supply systems are used to transmit such system interference to the other supply systems in attenuated form, this attenuation being better for a given cut-off frequency f_{c} of the low-pass filter the shorter the duration τ of the load current pulse. For a given duration τ of the load current pulse, the attenuation is better the lower the cut-off frequency f_{c} of the low-pass filter. That is to say, the decoupling effect of the low-pass connections is a monotonously increasing function of the expression 1/(τ*f_{c}).

In the case of the customary encapsulated IC modules, the package parasitics R_{P}, L_{P} and the internal smoothing capacitors C_{S} generally suffice to establish the low-pass connections using these elements and the external bridge conductors, said connections entailing satisfactory decoupling between the supply systems for the pulse loads which occur during operation. However, a wafer lacks the external bridge conductors for the ICs. Therefore, it was previously necessary to make contact with each supply system using a separate pair of needle probes when testing the ICs on the wafer, which required a large number of such probes for each IC.

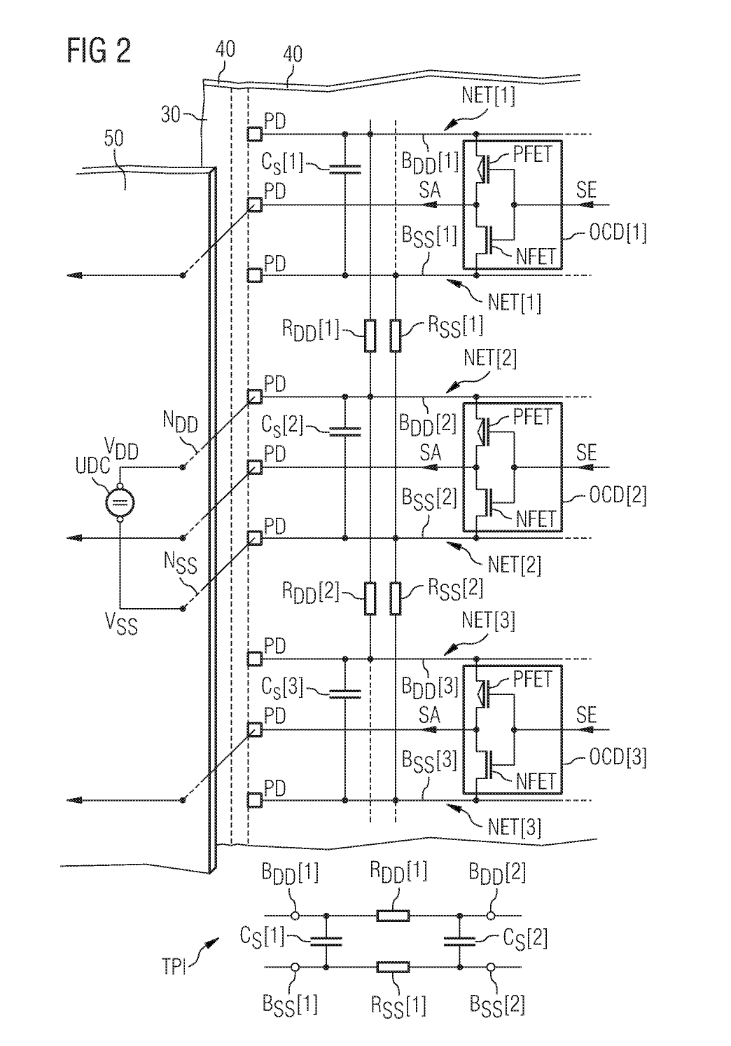

A relatively simple modification to the IC design makes it possible to carry out a wafer test using a reduced number of needle probes. This modification is illustrated in FIG. 2.

In the same fragmentary illustration as in FIG. 1, FIG. 2 shows an IC 30 which contains the same elements as the IC chip 10 shown in FIG. 1 and is integrated on a wafer 40 together with a large number of other similar ICs. A so-called “kerf” region of the wafer, which is subsequently removed by sawing in order to divide the wafer 40 into the individual chips, is indicated using bold dashed lines to the left of pads PD of the IC 30.

The modification to the IC 30 in comparison with the IC 10 shown in FIG. 1 comprises the positive busbars B_{DD} of the supply systems being internally DC-coupled to one another by means of first non-reactive resistors R_{DD} and the negative busbars B_{SS} of the supply systems being internally DC-coupled to one another by means of second non-reactive resistors R_{SS}. In order to apply the supply voltage to all systems which are connected to one another by means of the resistors R_{DD} and R_{SS}, it is thus sufficient to make contact only with the pads PD of a single one of these systems. A test card 50, as shown in fragmentary form in FIG. 2, thus requires only two needle probes N_{DD} and N_{SS} in order to connect all of the supply systems shown to a common DC voltage supply source UDC. For the sake of completeness, FIG. 2 illustrates the additional needle probes for making contact with the signal pads which are connected to the outputs SA of the drivers OCD[1:3] in order to supply the relevant output signals to a test unit (not shown) by means of the test card 50.

The internal coupling resistors R_{DD} and R_{SS} act, together with the internal smoothing capacitors C_{S}, as RC low-pass filters between the supply systems, with the result that the systems are decoupled in a frequency-dependent manner for alternating currents. Each of these low-pass connections can be considered to be a four-pole network having two parallel-path impedances each comprising one of the smoothing capacitors C_{S} and a respective series impedance in each of the two longitudinal branches between the parallel-path impedances. The series impedances are formed by the internal coupling resistors R_{DD} and R_{SS}. The bottom part of FIG. 2 illustrates such a low-pass four-pole network TPI, which leads via the internal coupling resistors, on its own, to be precise as an example of that which is effective between the two directly adjacent supply systems NET[1] and NET[2]. In this case, each series impedance has the resistance value of a coupling resistor. In the low-pass filters which act between supply systems which are further apart, the series resistances are each a multiple depending on the number of internal coupling resistors in series which are involved.

Said low-pass filters have a similar effect to the low-pass connections via the line parasitics in the encapsulated module. That is to say, interference pulses which are produced in a supply system as a result of a load current pulse are transmitted to the other supply systems in attenuated form, the degree of attenuation and thus the decoupling effect of the low-pass connections being inverse to the pulse duration and inverse to the cut-off frequency of the low-pass filters in this case too.

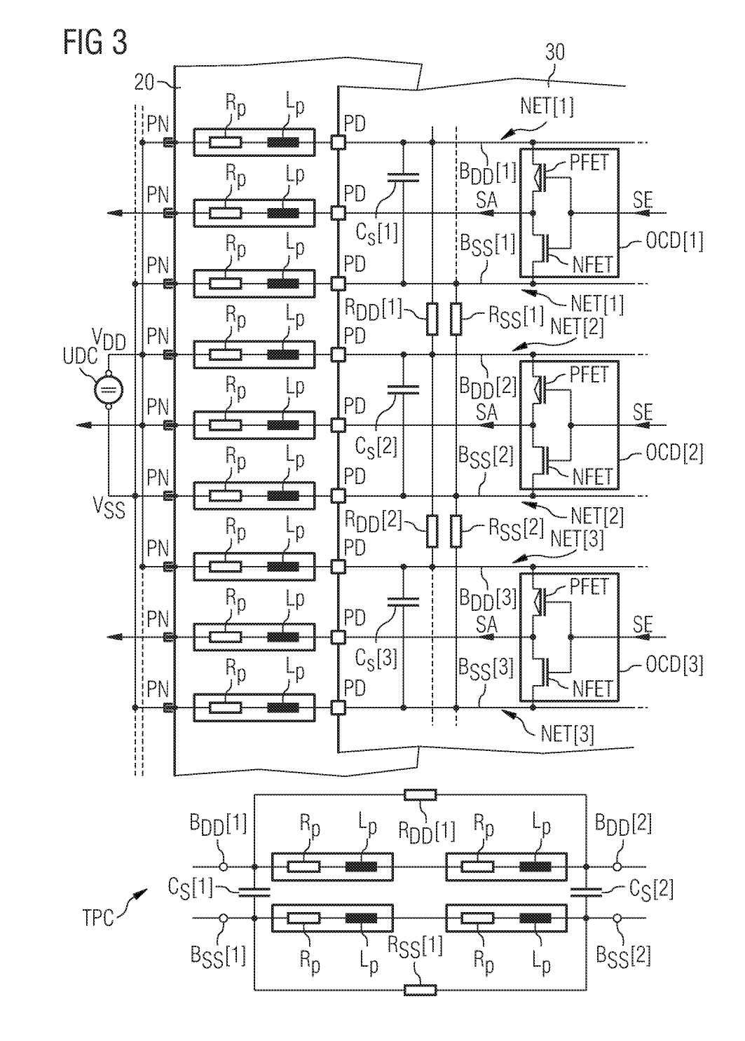

When dimensioning the internal coupling resistors R_{DD} and R_{SS}, it is necessary to take into account the fact that the IC 30 is encapsulated in a housing during subsequent use, the package parasitics R_{P} and L_{P} respectively being effective between the pads PD and the associated housing pins PN. This mounted state of the IC 30 is shown in FIG. 3. The illustration in FIG. 3 corresponds to that in FIG. 1 with the only difference that, instead of the IC 10, the IC 30 which has been modified and differs from the IC solely by virtue of the presence of the internal coupling resistors R_{DD} and R_{SS} is depicted.

In the encapsulated IC chip 30, the effect of the low-pass connections TPP, which lead via the package parasitics R_{P}, L_{P} and the external bridge conductors, is combined with the effect of the low-pass connections TPI, which lead via the internal coupling resistors R_{DD} and R_{SS}. The bottom part of FIG. 3 illustrates one of these combined low-pass filters TPC in the form of a four-pole network on its own, to be precise as an example of that which is effective between the two directly adjacent supply systems NET[1] and NET[2]. It can be seen that this low-pass filter TPC differs from the low-pass filter TPP which is effective in the IC 10 and is shown in FIG. 1 by virtue of the fact that one of the internal coupling resistors R_{DD} or R_{SS} is additionally connected in parallel with each longitudinal branch. This increases the AC coupling between the supply systems, that is to say the decoupling effected for alternating current becomes poorer the smaller the resistance value of the internal coupling resistors R_{DD} and R_{SS}. Therefore, in one advantageous embodiment of the invention, the resistance values R_{I} of the internal coupling resistors should be considerably larger than twice the non-reactive component R_{P} in the pad-pin wire connections. That is to say, R_{I}/R_{P}=m>2.

If the resistance value R_{I} of the internal coupling resistors R_{DD} and R_{SS} is considerably larger than the non-reactive component R_{P} in the pad-pin wire connections, the AC decoupling between the supply systems in an encapsulated module is not considerably poorer than in the case of implementation without the internal coupling resistors R_{DD} and R_{SS}. The greater degree of coupling during the wafer test with a small number of contact needles for the supply systems does not constitute a problem since the wafer test takes place at much lower frequencies than the final testing of “housed” (that is to say encapsulated) modules. This is due to the high values of the parasitics of needle cards. For example, a graphics memory is tested at a signal frequency of 100 MHz during the wafer test. In contrast, the final testing of the housed module is carried out at signal frequencies in the range from 500 to 1000 MHz.

The dimensioning of the resistors and frequencies according to the above example is highly suitable, in practice, for ICs which constitute DRAM modules, in particular graphics memories, the individual supply systems for individually supplying the individual data output drivers (OCDs) being connected, as schematically shown in the figures.

However, the embodiments of the invention are not restricted to such ICs. Internal low-pass coupler may be provided in any integrated circuit containing two or more separate supply systems for supplying power to different sections, with the result that the number of needle probes which make contact during the wafer test can be reduced.

One such advantage even results when only the supply systems of a subset of all supply systems are low-pass-coupled to one another. The low-pass coupling may also be organized in groups by dividing the systems into a plurality of disjoint groups of systems and setting up low-pass coupler only between the systems in the same group.

If a group of systems contains only two supply systems, two coupling resistors, one between the first busbars of the two systems and one between the second busbars of the two systems, are sufficient. FIGS. 2 and 3 show the example of a group of systems containing n>2 supply systems. In this case, a first resistor chain comprising n−1 first coupling resistors R_{SS} and a second resistor chain comprising n−1 second coupling resistors R_{DD} are provided, each resistor chain having n connection points, namely one connection point at each end and one connection point between respective adjacent elements in the chain. The n first busbars B_{DD} of the n supply systems are connected to the n connection points of the first resistor chain, and the n second busbars B_{SS} of the n supply systems are connected to the n connection points of the second resistor chain.

If a group of systems comprises three low-pass-coupled supply systems, contact needs to be made only with the pads of one of the systems during the wafer test, to be precise preferably the middle system, in order to feed the entire group. If a group of systems contains more than three low-pass-coupled systems, it may likewise be sufficient to make contact with only one of these systems during the wafer test. However, in the case of a group of systems having a large number of low-pass-coupled systems, it may be necessary to make contact with a plurality of systems in the group during the wafer test, for example every second or third or fourth etc. system in the group.

While the foregoing is directed to embodiments of the present invention, other and further embodiments of the invention may be devised without departing from the basic scope thereof, and the scope thereof is determined by the claims that follow.

What is claimed is:

1. An integrated circuit, comprising:
at least two supply systems, each of which is connected to an individually assigned section of the integrated circuit to supply power to the respective section and
a low-pass coupler connected between the at least two supply systems

2. The integrated circuit as claimed in claim 1, wherein each supply system comprises:
a first busbar for the positive potential of a supply voltage and a second busbar for the negative potential of the supply voltage, wherein the low-pass coupler is set up between the first busbar and the second busbar of the at least two supply systems.

3. The integrated circuit as claimed in claim 2, wherein each busbar comprises an integrated contact area, wherein a relevant supply potential from an external voltage source is applied to the integrated contact area.

4. The integrated circuit as claimed in claim 1, wherein the low-pass coupler between two respective supply systems is formed by a low-pass four-pole network, one connection pair of the low-pass four-pole network connected to one supply system and the other connection pair of the low-pass four-pole network connected to the other supply system.

5. The integrated circuit as claimed in claim 4, wherein the low-pass four-pole network comprises two longitudinal branches each having a connection which conducts direct current and is routed via a coupling resistor, a respective parallel-path capacitance being provided on both sides of the coupling resistor.

6. The integrated circuit as claimed in claim 5, wherein the parallel-path capacitances of the low-pass four-pole network are formed by smoothing capacitors.

7. The integrated circuit as claimed in claim 5, wherein the resistance value of each coupling resistor is the same.

8. The integrated circuit as claimed in claim 5, wherein the resistance value of each coupling resistor is more than twice as high as a resistance value of wiring which is connected between contact areas of the integrated circuit and pins of a housing that surrounds the integrated circuit.

9. The integrated circuit as claimed in claim 1, wherein the at least two supply systems comprises n supply systems wherein n is an integer greater than 2, each supply system being connected to an individually assigned section of the integrated circuit to supply power to the relevant section, and further comprising:
a first resistor chain comprising n−1 first coupling resistors and a second resistor chain comprising n−1 second coupling resistors, each resistor chain having n connection points, one connection point at each end and one connection point between respective adjacent elements in the chain, and
n first busbars of the n supply systems connected to the n connection points of the first resistor chain and n second busbars of the n supply systems connected to the n connection points of the second resistor chain.

10. The integrated circuit as claimed in claim 9, wherein a parallel-path capacitance is provided on both sides of each coupling resistor.

11. The integrated circuit as claimed in claim 10, wherein the parallel-path capacitance is formed by a smoothing capacitor.

12. The integrated circuit as claimed in claim 9, wherein the resistance value of each coupling resistor is the same.

13. The integrated circuit as claimed in claim 9, wherein the resistance value of each coupling resistor is more than twice as high as a resistance value of wiring which is connected between contact areas of the integrated circuit and pins of a housing that surrounds the integrated circuit.

14. A dynamic random access memory (DRAM) module comprising:
at least two power supply systems each of which is connected to a data output driver to supply power to the data output driver; and
a low-pass coupler connected between the at least two power supply systems.

15. The DRAM module as claimed in claim 14, wherein each power supply system comprises:
a first busbar for the positive potential of a supply voltage and a second busbar for the negative potential of the supply voltage, wherein the low-pass coupler is set up between the first busbar and the second busbar of the at least two supply systems.

16. The DRAM module as claimed in claim 15, wherein each busbar comprises an integrated contact area, wherein a relevant supply potential from an external voltage source is applied to the integrated contact area.

17. The DRAM module as claimed in claim 14, wherein the low-pass coupler between two respective power supply systems is formed by a low-pass four-pole network, one connection pair of the low-pass four-pole network connected to one power supply system and the other connection pair of the low-pass four-pole network connected to the other power supply system.

18. The DRAM module as claimed in claim 17, wherein the low-pass four-pole network comprises two longitudinal branches each having a connection which conducts direct current and is routed via a coupling resistor, a respective parallel-path capacitance being provided on both sides of the coupling resistor.

19. The DRAM module as claimed in claim 18, wherein the parallel-path capacitances of the low-pass four-pole network are formed by smoothing capacitors.

20. The DRAM module as claimed in claim 18, the resistance value of each coupling resistor is the same.

21. The DRAM module as claimed in claim 18, wherein the resistance value of the coupling resistor is more than twice as high as the resistance value of wiring which is connected between contact areas of the integrated circuit and pins of a housing that surrounds the DRAM module.

22. The DRAM module as claimed in claim 14, wherein the at least two power supply systems comprises n supply systems wherein n is an integer greater than 2, each power supply system being connected to an individually assigned section of the DRAM module to supply power to the relevant section, and further comprising,
a first resistor chain comprising n−1 first coupling resistors and a second resistor chain comprising n−1 second coupling resistors, each resistor chain having n connection points, one connection point at each end and one connection point between respective adjacent elements in the chain, and
n first busbars of the n supply systems connected to the n connection points of the first resistor chain and n second busbars of the n supply systems connected to the n connection points of the second resistor chain.
